(19) United States
(12) Patent Application Publication
(10) Pub. No.: US 2014/0069251 A1
(43) Pub. Date: Mar. 13, 2014

(54) FOOD PRODUCT SLICER

(71) Applicant: POTBELLY SANDWICH WORKS, LLC, (US)

(72) Inventor: Carl Segal, Highland Park, IL (US)

(73) Assignee: POTBELLY SANDWICH WORKS, LLC, Chicago, IL (US)

(21) Appl. No.: 13/773,240

(22) Filed: Feb. 21, 2013

Related U.S. Application Data
(60) Provisional application No. 61/691,988, filed on Aug. 22, 2012.

(51) Int. Cl. B26B 5/00; B26D 3/30

(52) U.S. Cl. CPC B26B 5/007; B26D 3/30
USPC 83/870; 30/296.1; 83/13

(57) ABSTRACT

Food product slicers that efficiently, consistently, and safely slice food products are disclosed herein. Embodiments of a food product slicer comprise a base unit and a cutting utensil. Additional embodiments of the food product slicer comprise a base unit, a handle, and a cutting utensil. Further embodiments of the food product slicer comprise a base unit having a first side, a second side, a top surface and a bottom surface; a cutting utensil attached to the base unit at a predetermined distance from the bottom surface of the base unit, the cutting utensil having a cutting edge parallel to the bottom surface of the base unit; and a handle attached to the base unit.

### RELATED APPLICATIONS

This application claims priority to U.S. Provisional Application No. 61/691,988, filed Aug. 22, 2012, the entire contents of which is hereby incorporated by reference herein.

### FIELD

The present disclosure relates generally to devices and methods for efficiently, consistently, and safely slicing food products. More particularly, the present invention is related to a manual food slicer for slicing food products, such as bread products, having a base unit, handle, and cutting utensil.

### BACKGROUND

Manual food slicers are widely utilized as rapid and effective means for slicing a variety of food products including bread products such as bagels, English muffins and dinner rolls. The food slicers commonly include a conventional handle for manual operation of the food slicer and a blade for cutting the food product. The handle, on one end of the food slicer, is generally adjacent to the blade, which is found on the other end of the food slicer. Examples of manual food slicers are knives regularly found in the kitchen, such as bread knives, Chef's knives and cleavers.

In general, a user maneuvers the food slicer by hand, without mechanical aid, in order to use the corresponding blade to slice the food product. The user typically grips the food slicer with his or her dominant hand leaving his or her non-dominant hand free to control the food product being sliced. For instance, bread products can be sliced by holding, for example, a loaf of bread in one hand, a knife in the other hand, and cutting into the loaf. Because the user can freely manipulate the knife in any direction, the user can easily lose control while cutting the food product. This approach can result in uneven and inconsistent cuts, and even worse, serious injury.

When preparing foods, however, it can be desirable to have several slices of a food product be of an even and uniform thickness. It can also be desirable for a food product to be cut so that it is not sliced completely into separate individual portions, but rather, is cut partially into even slices where the cutting utensil only penetrates a portion of the food product. Yet it is exceptionally difficult to routinely achieve an even and uniformly thick slice, or partial cut, when using a manual food slicer such as a knife.

Furthermore, the blade of prior art food slicers, whether sharp or dull, can be a safety hazard when used to slice food products. Because the food product to be sliced is guided by hand against a sharp blade, the user can become cut or nicked on the blade, or suffer more serious injuries.

In view of the above, it would be beneficial to have a device for efficiently, consistently, and safely slicing food products, such as bread products.

### SUMMARY

Disclosed herein is a novel food product slicer.

The food product slicer of the present invention generally comprises a base unit and a cutting utensil. In one aspect, the cutting utensil, such as a blade, is secured to one side of the base unit at a fixed distance above the bottom surface of the base unit, such that the cutting edge of the cutting utensil is parallel to a planar cutting surface adjacent to the bottom surface of the base unit. The planar cutting surface, such as a table or a countertop, also abuts the product to be sliced thereon. Thus, when slicing a food product, both the bottom surface of the base unit and the food product rests on the planar cutting surface. The food product slicer glides across the planar cutting surface in a horizontal motion while the cutting utensil cuts into the food product. The food product accordingly can be sliced into portions which are uniform and of a consistent thickness.

In another aspect, the cutting utensil of the food product slicer may be adjusted in order to vary the thickness of the slice of the food product. The cutting utensil also may be of a specific width such that it does not completely slice the food product into individual pieces. By controlling the depth of the cut of the cutting utensil and preventing it from cutting all the way through the food product, the user can safely and efficiently make partial cuts of a predetermined thickness. The present invention accordingly allows the user to be more efficient and expeditious because he or she will not have to be concerned about being cut by the cutting utensil as he or she cuts into the food product.

In another aspect, the food product slicer comprises a base unit, a cutting utensil, and a handle. The handle, which a user can utilize to control movement of the food product slicer, may be affixed to the top of the base unit. The handle also may have an ergonomic design and/or enable the food product slicer to be used by either a right-handed or left-handed user.

In yet another aspect, the food product slicer comprises a base unit having a first side, a second side, a top surface and a bottom surface; a cutting utensil attached to the base unit at a predetermined distance from the bottom surface of the base unit, the cutting utensil having a cutting edge parallel to the bottom surface of the base unit; and a handle attached to the base unit.

Accordingly, it is an object of the present invention to provide a handheld tool for slicing food products such as bread products.

It is another object of the present invention to provide a food product slicer that is safe, reliable and easy to use for slicing food products such as bread products.

Another object of the present invention is to provide a food product slicer that is capable of slicing food products completely into individual portions having a predetermined thickness, or partially into slices also having a predetermined thickness where the food product slicer cuts into the food product, but does not cut it into separate portions.

A further object of the present invention is to provide a method for efficiently, consistently and safely slicing food products, such as bread products.

These, and other embodiments, objects, features and advantages will be set forth in the detailed description of the embodiments that follows, with reference where appropriate to the accompanying drawings, and in part will be apparent from the description, or may be learned by practice, of the claimed invention. These objects and advantages will be realized and attained by the devices and methods described and claimed herein. Further, the foregoing summary is merely illustrative and has been made with the understanding that it is to be considered as a brief and general synopsis of some of the embodiments disclosed herein, is provided solely for the benefit and convenience of the reader, and is not intended to limit in any manner the scope, or range of equivalents, to which the appended claims are lawfully entitled.

### BRIEF DESCRIPTION OF THE DRAWINGS

The accompanying drawings illustrate various embodiments of a food product slicer.

FIG. 1 is a perspective view of an embodiment of the food product slicer disclosed herein.

FIG. 2 is another perspective view of the food product slicer of FIG. 1.

FIG. 3 is a perspective view of several embodiments of the food product slicer disclosed herein.

FIG. 4 is another perspective view of the several embodiments of the food product slicer of FIG. 3.

FIG. 5 is a perspective view of an embodiment of the food product slicer disclosed herein which includes a measuring ruler positioned alongside the length of the food product slicer.

FIG. 6 is a perspective view of an embodiment of the food product slicer disclosed herein which includes a measuring ruler positioned alongside the width of the food product slicer.

FIG. 7 is a perspective view of an embodiment of the food product slicer disclosed herein which includes a measuring ruler positioned alongside the height of the food product slicer.

FIG. 8 is a perspective view of an embodiment of the food product slicer disclosed herein in which the base unit of the food product slicer has been taken apart at the disassembly location and a measuring ruler has been placed alongside the length of the embedded cutting utensil.

FIG. 9 is a perspective view of an embodiment of the food product slicer disclosed herein which includes a measuring ruler positioned alongside the width of the cutting utensil.

FIG. 10 is a perspective view of an embodiment of the food product slicer disclosed herein in which the handle of the food product slicer has been removed from the base unit.

FIG. 11 is a perspective view of an embodiment of the food product slicer disclosed herein in which the base unit of the slicer has been taken apart at the disassembly location.

FIG. 12 is a perspective view of a disassembled food product slicer in accordance with an embodiment of the disclosed invention.

FIG. 13 is a perspective view of an embodiment of the food product slicer disclosed herein.

FIG. 14 is a perspective view of an embodiment of the food product slicer disclosed herein in which the food product slicer contains a circular cutting tool.

FIG. 15 is a perspective view of an embodiment of the food product slicer disclosed herein in which the food product slicer is slicing into a loaf of bread.

FIG. 16 is a perspective view of an embodiment of the food product slicer disclosed herein in which the food product slicer is slicing into a loaf of bread.

FIG. 17 is a perspective view of an embodiment of the food product slicer disclosed herein in which the food product slicer contains a circular cutting tool.

FIG. 18 is a perspective view of an embodiment of the food product slicer disclosed herein in which the food product slicer contains a circular cutting tool.

### DETAILED DESCRIPTION

The various embodiments disclosed and described herein present food product slicers.

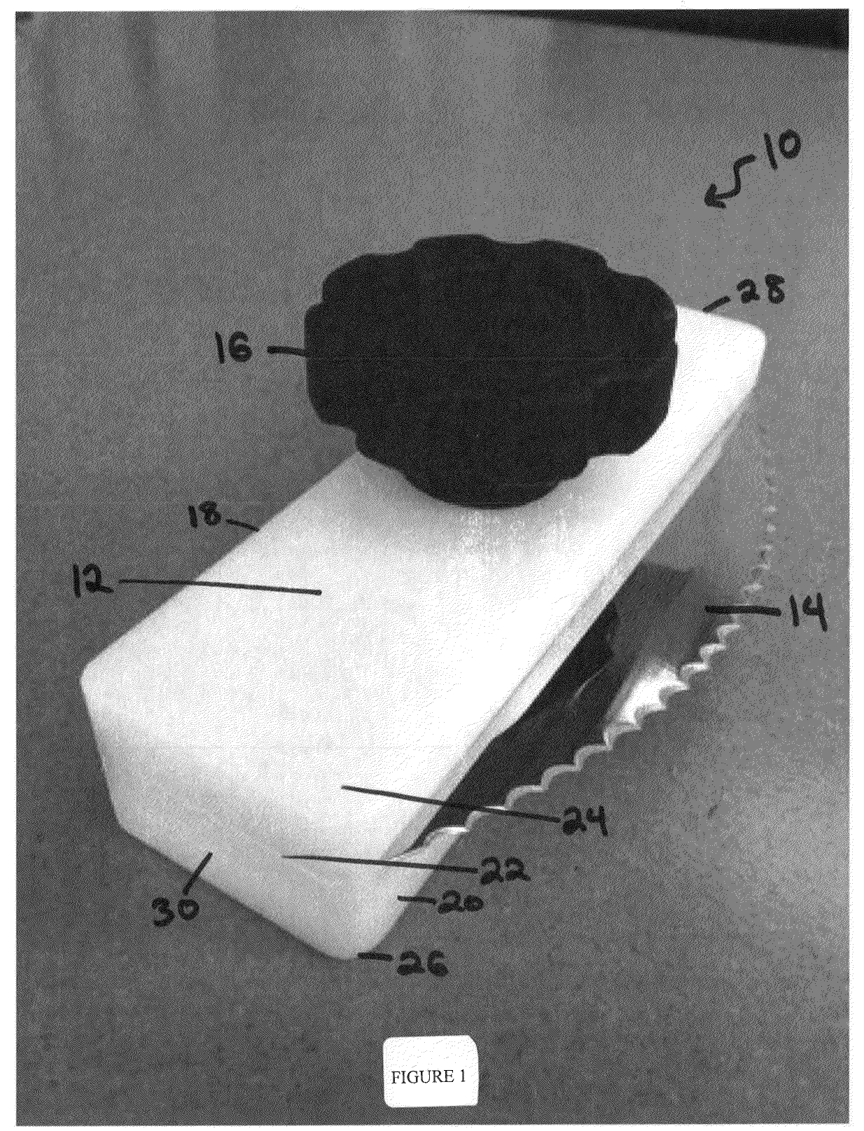

Referring to FIG. 1, a food product slicer 10 includes a base unit 12, a cutting utensil 14, and a handle 16. The base unit 12 comprises a first side 20, a second side 18, a top surface 24, a bottom surface 26, a first end 28 and a second end 30.

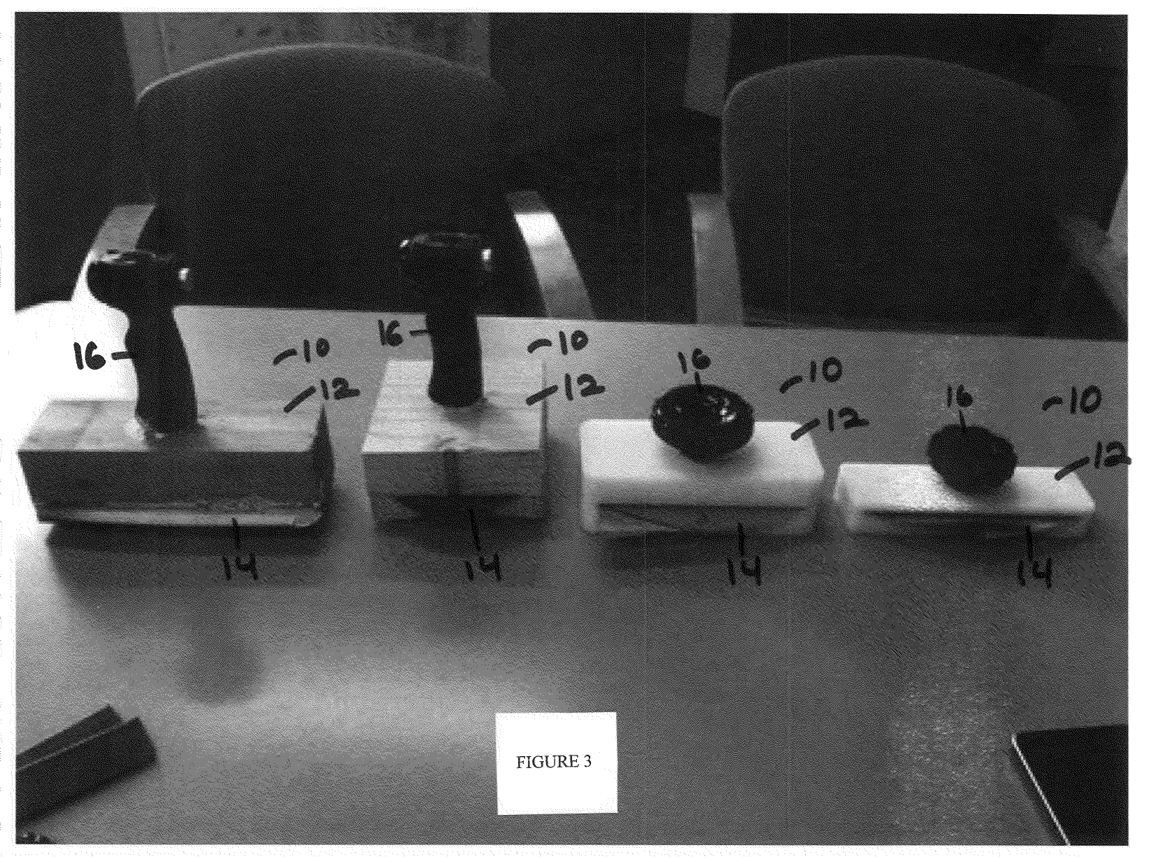

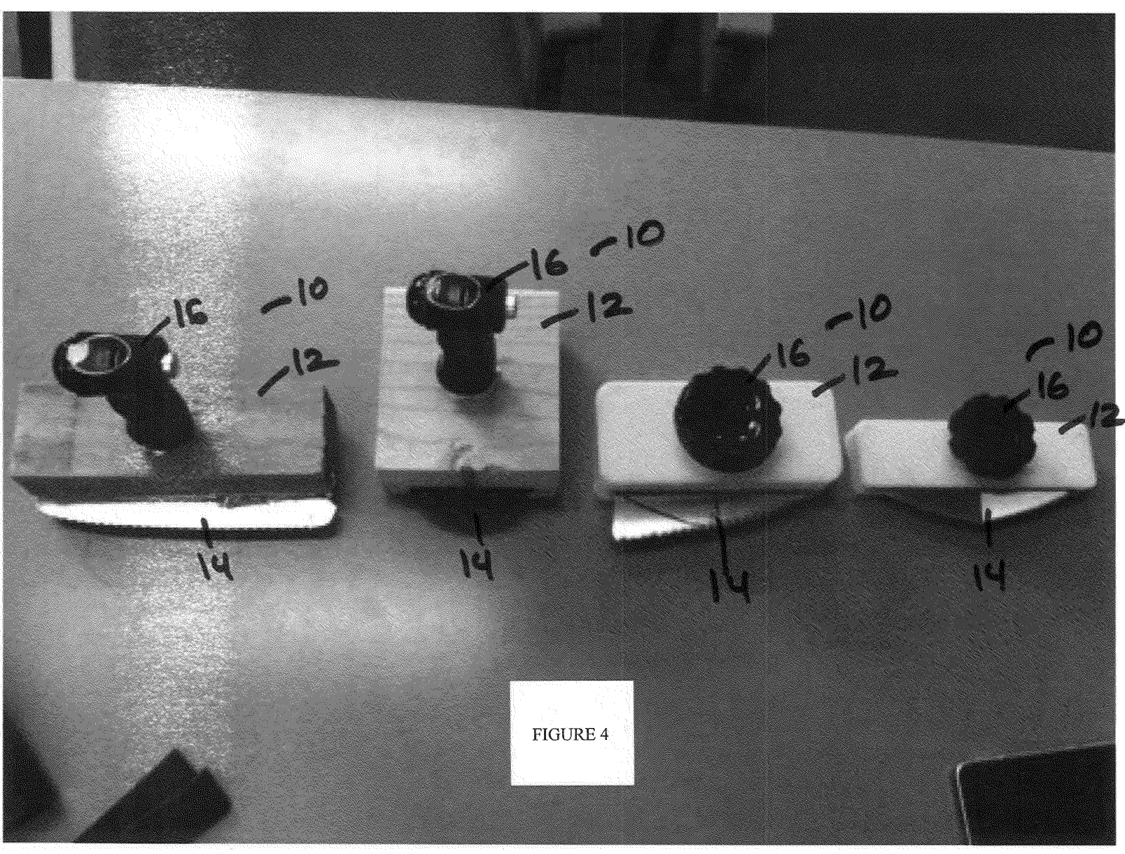

The base unit 12 may be comprised of a variety of materials, including, but not limited to, plastic, including high-strength molded plastic, metal, including galvanized metal or a lightweight alloy such as aluminum, wood, stone, or rubber. In one embodiment, as depicted in FIG. 1, the base unit 12 is comprised of molded plastic. FIGS. 3 and 4 depict embodiments of food product slicers 10 having base units 12 made of wood, and food product slicers 10 having base units 12 made of plastic. In another embodiment, the base unit 12 is made from a material that is approved by the U.S. Food and Drug Administration (FDA), U.S. Department of Agriculture (USDA), or the National Sanitation Foundation International (NSF) for use in the food industry. The base unit 12 may also be made of any food-grade material, including those food grade materials that can glide on a flat surface. All or portions of the base unit 12 may be hollow in order to decrease the weight of the food product slicer 10.

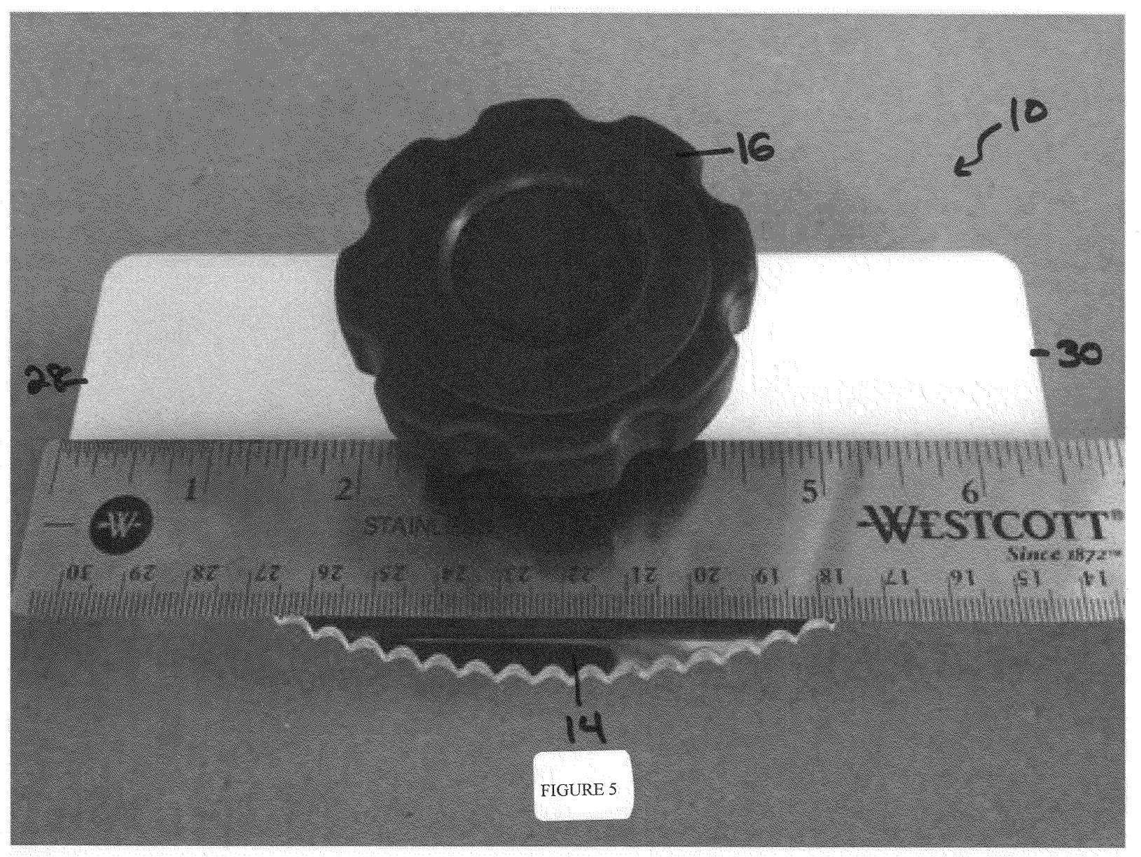

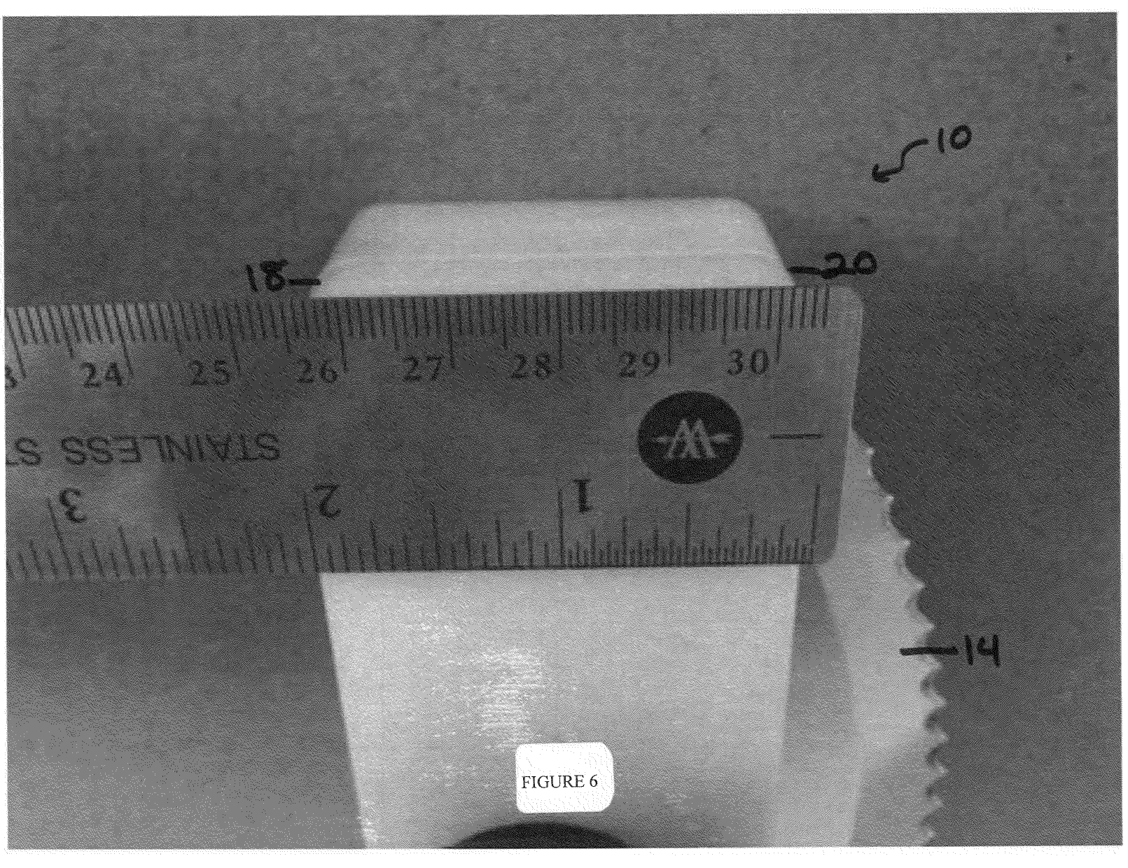

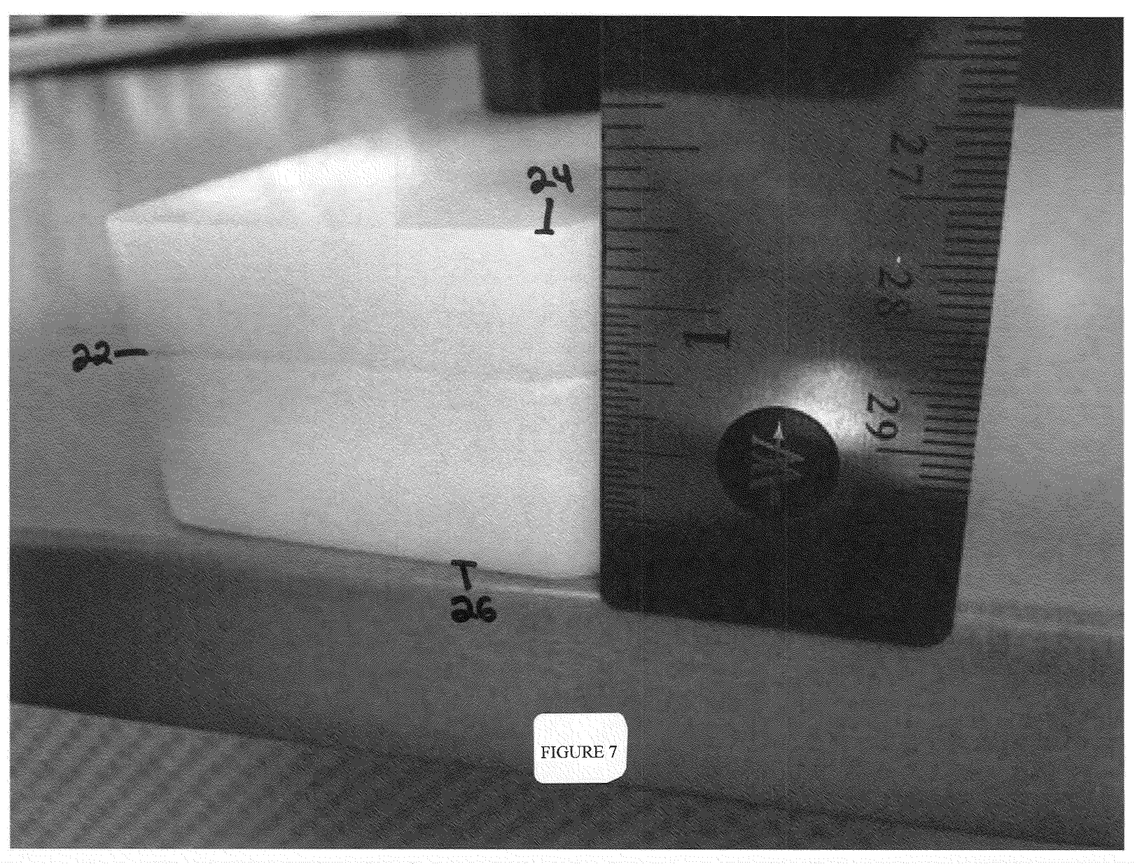

As shown in FIGS. 3 and 4, the base unit 12 may be any size and shape. In one embodiment, the base unit 12 is a rectangle, square, oval, triangle, circle, or rhombus. FIG. 1 depicts the base unit 12 having a rectangular shape. FIGS. 3 and 4 depict food product slicers 10 having base units 12 of rectangular and square shapes. In another embodiment, as shown in FIGS. 5-7, the base unit 12 has a length (measured from the first end 28 to the second end 30) greater than about 3 inches, a width (measured from the first side 20 to the second side 18) greater than about 1 inch, and a height (measured from the bottom surface 26 to the top surface 24) greater than about 0.5 inches. In still another embodiment, the base unit 12 has a length of about 3 inches to about 18 inches, a width of about 1 inch to about 6 inches, and a height of about 0.5 inches to about 8 inches. In a further embodiment, the base unit 12 has a length of about 5 inches to about 8 inches, a width of about 2 inches to about 4 inches, and a height of about 1 inch to about 3 inches. In yet another embodiment, the base unit 12 has a length of about 6.5 inches, a width of about 2 inches, and a height of about 1.25 inches.

The bottom surface 26 of the base unit 12 is generally planar. When slicing a food product, the bottom surface 26 preferably lies in a plane parallel to the plane of a generally planar cutting surface, such as a table or a countertop. The bottom surface 26 of the base unit 12 rests on the planar cutting surface and may further comprise one or more tabs, strips, feet or roller bearings that are affixed to the bottom surface 26 to assist such bottom surface 26 in gliding across the planar cutting surface. Such tabs, strips, feet or roller bearings may be made of any material that allows the bottom surface 26 to glide smoothly along the planar cutting surface, or that reduces friction between the bottom surface 26 and the planar cutting surface.

Referring back to FIG. 1, the base unit 12 also comprises a cutting utensil 14. The cutting utensil 14 is embedded into the first side 20 of the base unit 12. Those skilled in the art will appreciate that the cutting utensil 14 can be affixed to, or embedded into, the base unit 12 in a number of ways including by means of pins, screws, adhesive, fasteners, a snap-together assembly or other connections. For example, the base unit 12 and cutting utensil 14 can be secured to each other by means of screws, wherein each of the base unit 12 and cutting utensil 14 include one or more holes for receiving one or more screws. Alternatively, the first side 20 of the base unit 12 can comprise a slot for receiving the end of the cutting utensil 14 opposite the cutting edge. The bottom surface 26 or top surface 24 can also comprise a slot for receiving the edge of the cutting utensil 14 opposite the cutting edge.

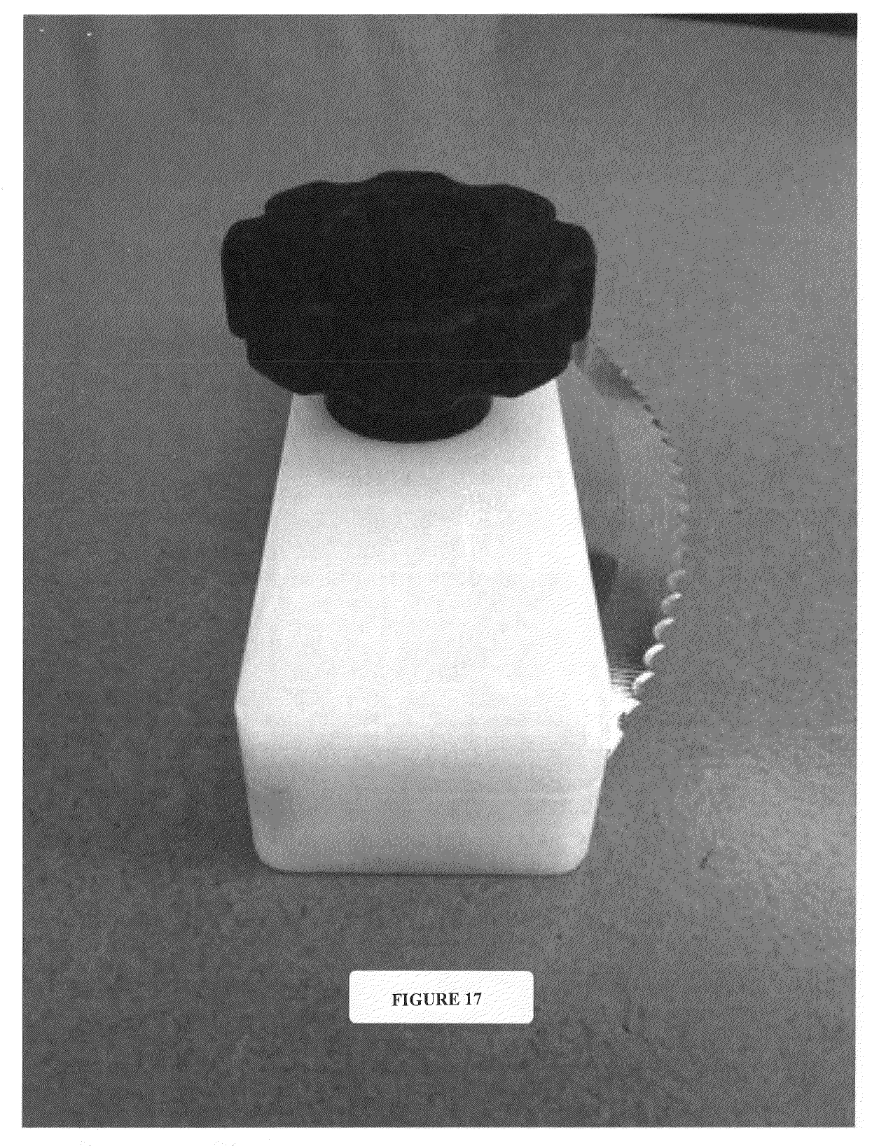

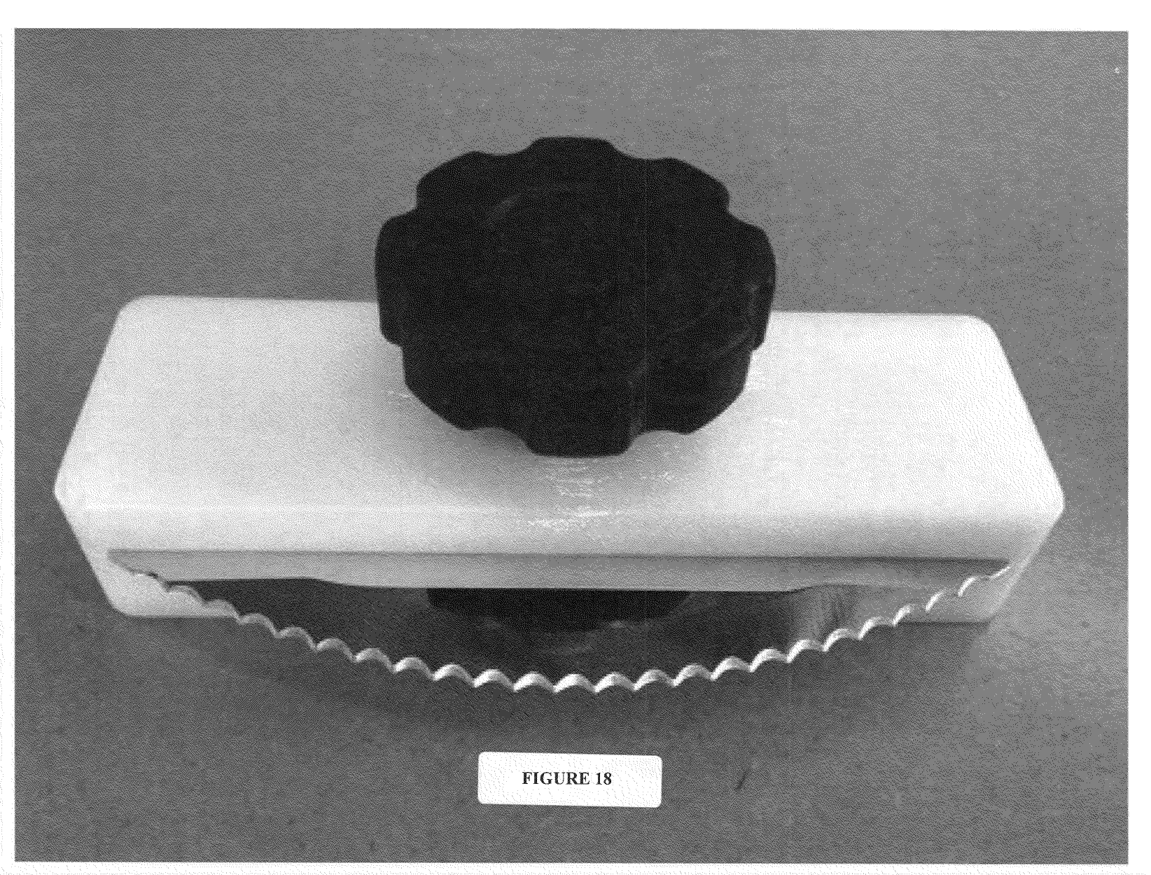

The cutting utensil 14 may be made from any material and take any shape that enables the cutting utensil 14 to slice a food product. For example, as shown in FIGS. 3 and 4, the cutting utensil 14 can be circular, rectangular, or triangular in shape. In one embodiment, as depicted in for example, FIGS. 1, 17 and 18, the cutting utensil 14 has a circular shape. The cutting utensil 14 can be made of plastic, metal, such as stainless steel, carbon steel or alloys, composites, or other abrasives set into metal. The cutting utensil 14 also can be made from any material that is approved by the FDA, USDA, or NSF for use in the food industry. In another embodiment, the cutting utensil 14 is comprised of one solid material, such as one piece of plastic or metal. In another embodiment, the cutting utensil 14 is comprised of one or more pieces of plastic, metal, or FDA, USDA, or NSF approved material. Referring to FIGS. 3 and 4, the cutting edge of the cutting utensil 14 can be straight, serrated, sawtooth with several teeth of various shapes, stiff wire, sharpened, unsharpened, or coated. The exemplary cutting utensil 14 of FIG. 1 is serrated. In an embodiment, the cutting utensil 14 is made of metal and has a straight cutting edge. In another embodiment, the cutting utensil 14 is made of metal and has a serrated cutting edge.

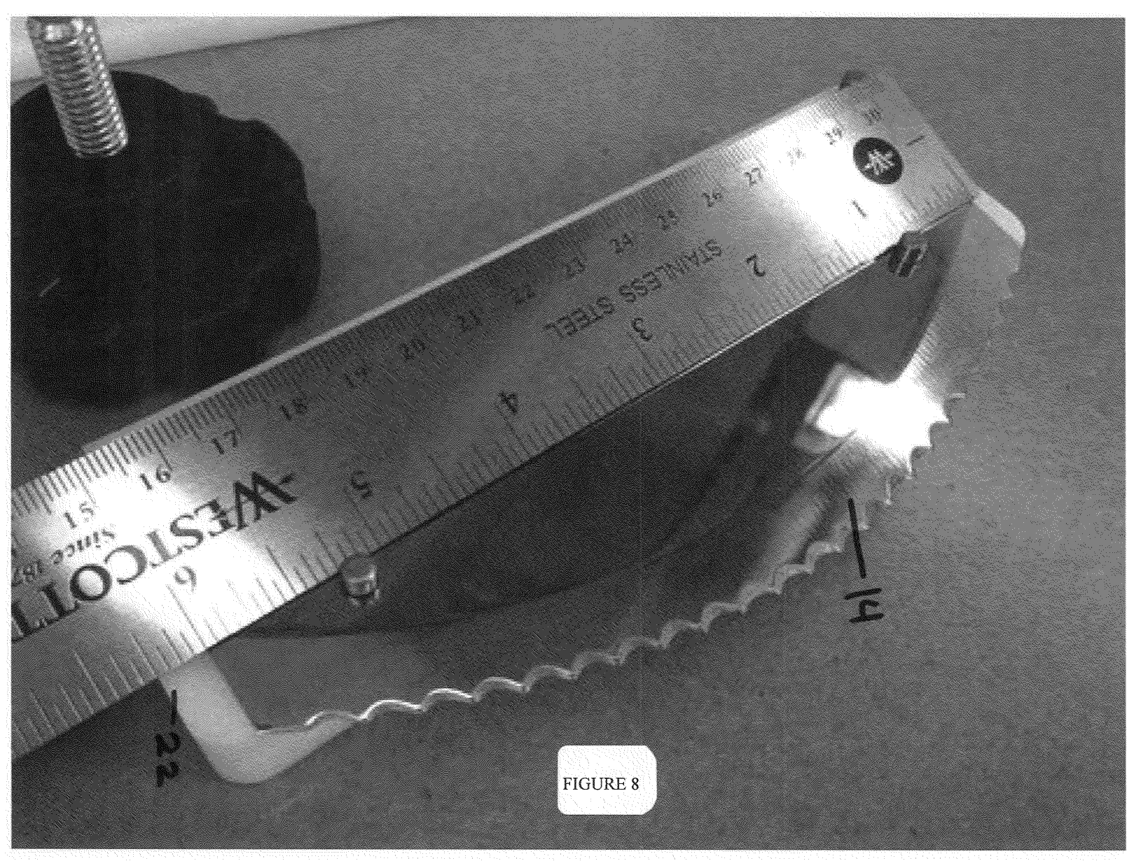

The cutting utensil 14 may have a length equal to or less than the length of the base unit 12. In one embodiment, the cutting utensil 14 has a length equal to the length of the base unit 12. As shown in FIG. 8, in an additional embodiment, the cutting utensil 14 has a length which is less than the length of the base unit 12.

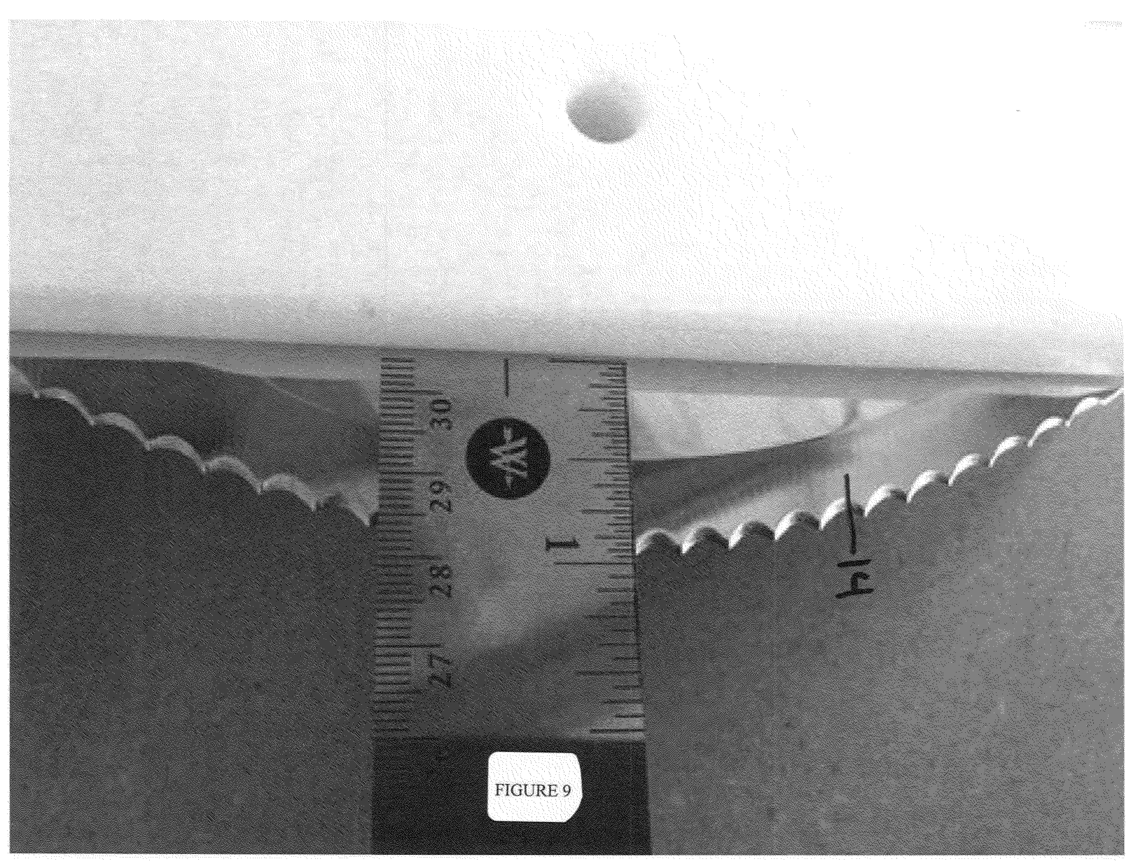

The width of the cutting utensil 14 (measured from the point of the cutting edge farthest away from the first side 20 of the base unit, to the first side 20 of the base unit 12) can also be varied. In an embodiment, the cutting utensil 14 has a width greater than 1 inch. In another embodiment, the cutting utensil 14 has a width of about 10 inches, 9 inches, 8 inches, 7 inches, 6 inches, 5 inches, 4 inches, 3 inches, 2 inches, 1 inch or 0.5 inches. In still another embodiment, as illustrated in FIG. 9, the cutting utensil 14 has a width of about 1 inch.

In one embodiment, the width of the cutting utensil 14 is greater than the width of the food product to be sliced such that a single horizontal slice from the food product slicer 10 is capable of completely separating the food product into individual portions. In another embodiment, the width of the cutting utensil 14 is less than the width of the food product to be sliced such that a single horizontal cut from the food product slicer 10 is incapable of completely separating the food product. Instead, the food product is cut into a parallel incomplete slice occurring on only one side of the food product. The food product may then be spread along the incomplete cut like opening a book. The depth of the cut of the cutting utensil 14 can accordingly be limited so that the cut occurs only on one side of the food product. For example, as described above, a specific size of cutting utensil 14 can be utilized in order to ensure depth of cut based on the dimensions of the food product. Controlling the depth of cut can provide for safe use of the food product slicer 10 because the cutting utensil 14 can be prevented from cutting all the way through the food product and slicing the user's hand. One of skill the art will appreciate that numerous alternate embodiments used to limit depth of cut may be constructed such as a movable or removable member which can act in turn as a blade guard or be placed sequentially behind the cutting utensil 14 to extend the area of the cutting utensil 14, or a cutting-depth limiter.

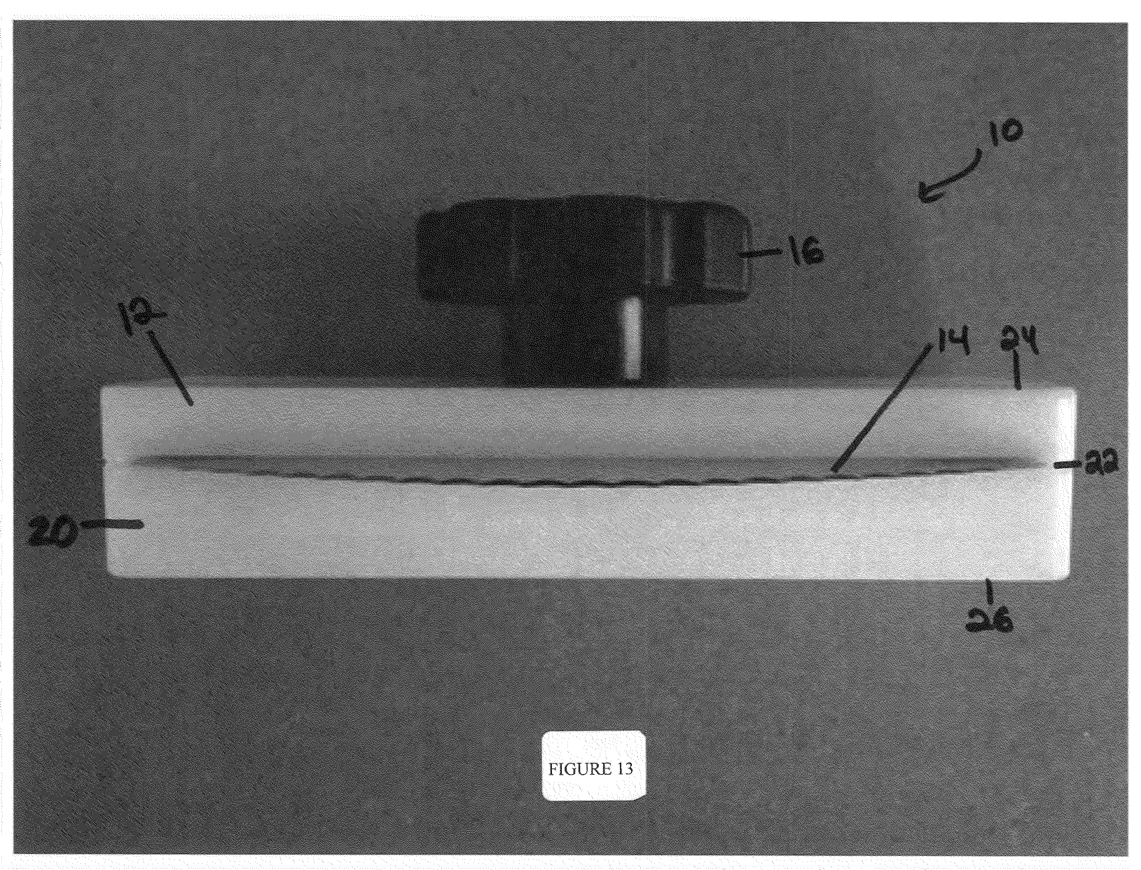

As exemplified in FIG. 13, in one embodiment, the cutting utensil 14 is secured to the first side 20 of the base unit 12 at a fixed distance above the bottom surface 26 of the base unit 12, such that the cutting edge of the cutting utensil 14 is parallel to a planar cutting surface adjacent to the bottom surface 26. The planar cutting surface also abuts the food product to be sliced thereon. In another embodiment, when slicing a food product, both the bottom surface 26 of the base unit 12 and the food product rests on the planar cutting surface. The food product slicer 10 glides across the planar cutting surface in a horizontal direction while the cutting utensil 14 cuts into the food product. The food product accordingly can be sliced into portions which are uniform and of a consistent and predetermined thickness based on the distance of the cutting utensil 14 from the bottom surface 26 of the base unit 12.

In one embodiment, the cutting utensil 14 is affixed to the base unit 12 so that the cutting utensil 14 sits parallel to, and more than approximately 0.25 inches above, the bottom surface 26 of the base unit 12. In another embodiment, the cutting utensil 14 is affixed to the base unit 12 so that the cutting utensil 14 sits approximately 0.25 inches to approximately 3 inches above the bottom surface 26. In yet another embodiment, the cutting utensil 14 is affixed to the base unit 12 so that the cutting utensil 14 sits approximately 0.1 inches to approximately 6 inches above the bottom surface 26. In an additional embodiment, the cutting utensil 14 is affixed to the base unit 12 so that the cutting utensil 14 sits approximately 0.5 inches to approximately 1 inch above the bottom surface 26. In another embodiment, the cutting utensil 14 is embedded into the base unit 12 so that the cutting utensil 14 sits approximately 0.75 inches above the bottom surface 26. In yet another embodiment, the cutting utensil 14 is attached to either the top surface 24 or the bottom surface 26 of the base unit 12.

The cutting utensil 14 may be permanently attached or affixed to the base unit 12. The cutting utensil 14 also may be detachable and replaceable with different cutting utensils 14, such as blades, of differing sizes or shapes. Where the cutting utensil 14 is detachable, the base unit 12 can be disassembled in order to replace the cutting utensil 14.

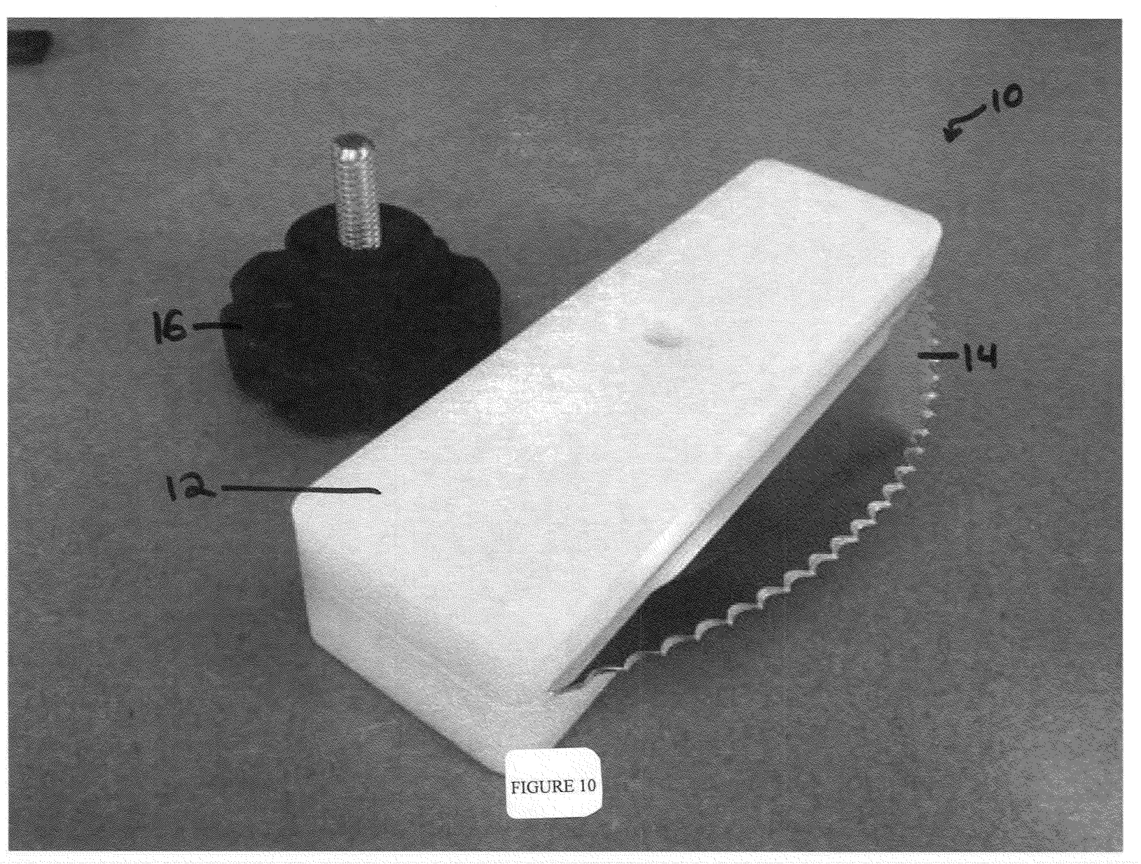

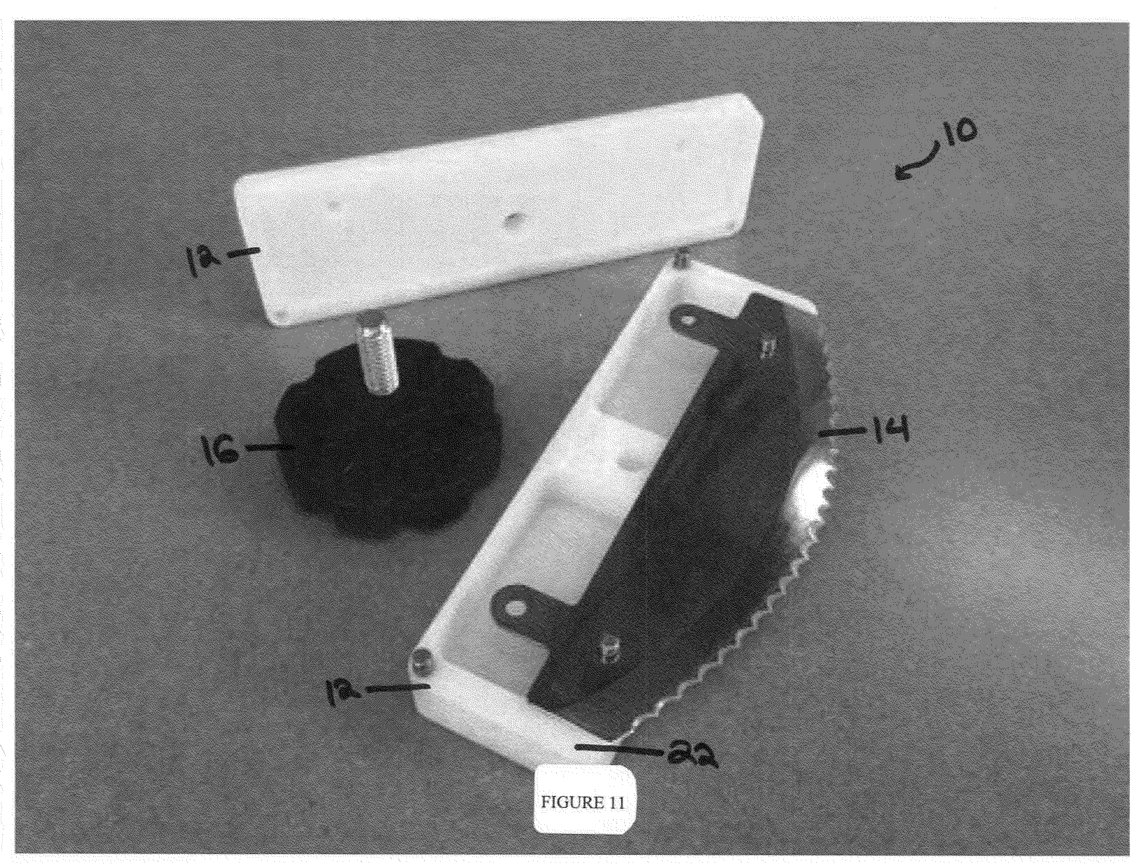

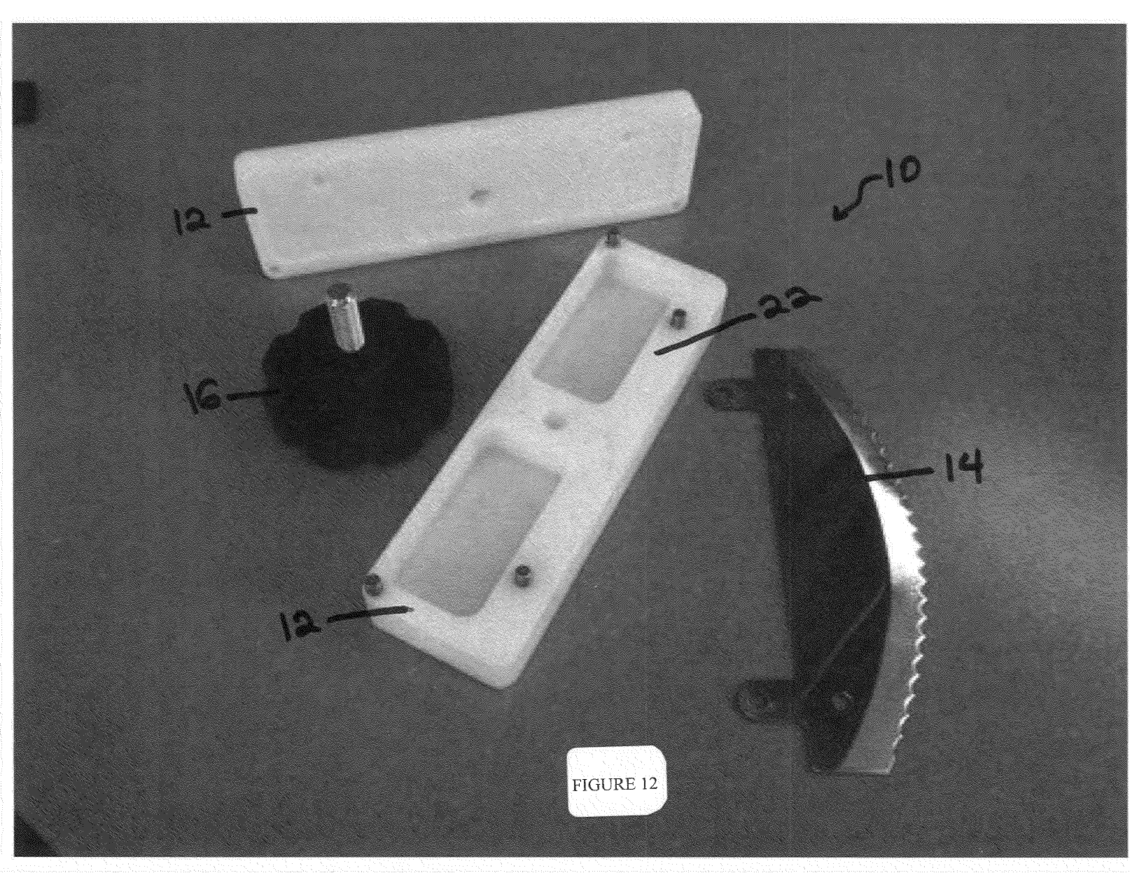

Referring to FIG. 1, the base unit 12 can be taken apart at disassembly location 22. In one embodiment, as depicted in FIGS. 11 and 12, a user can take apart the base unit 12 along the horizontal plane of disassembly location 22 such that the base unit 12 separates into two parallel parts and the cutting utensil 14, which is affixed in the disassembly location 22, is no longer embedded or affixed to the base unit 12. The user can then remove the cutting utensil 14, place a different cutting utensil 14 into the base unit 12, and reassemble the base unit 12 with the replaced cutting utensil 14 by putting the two separated parallel parts of the base unit 12 back together at disassembly location 22. Disassembly location 22 can be formed in any manner known by those of skill in the art such as by means of pins, screws, adhesive, snaps, fasteners, or other connectors. For example, as shown in FIGS. 11 and 12, the separable horizontal plane of disassembly location 22 can be held together by means of a snap-together assembly wherein mating male and female members are located on each side of the separated horizontal plane, such as protrusions and indentations, which snap fit together so that the base unit 12 is a single unit. A user can take apart the base unit 12 at the disassembly location 22 by separating such male and female members, or reassemble the base unit 12 at the disassembly location 22 by snapping together the corresponding male and female members. In another example, the separable horizontal plane of disassembly location 22 can be held together by one or more screws. In yet another embodiment, as shown in FIG. 10, the handle contains a long screw or pin protruding from the bottom of the handle which can secure the separable horizontal plane of disassembly location 22.

In an additional embodiment, the cutting utensil 14 may also be detachable and replaced without requiring disassembly of the base unit 12. For example, the cutting utensil 14 can be connected to the base unit 12 by means of a slot in the first side 20 of the base unit 12 for receiving the cutting utensil 14. The cutting utensil 14 can accordingly be removed from such slot and replaced with a different cutting utensil 14 that is inserted into the slot.

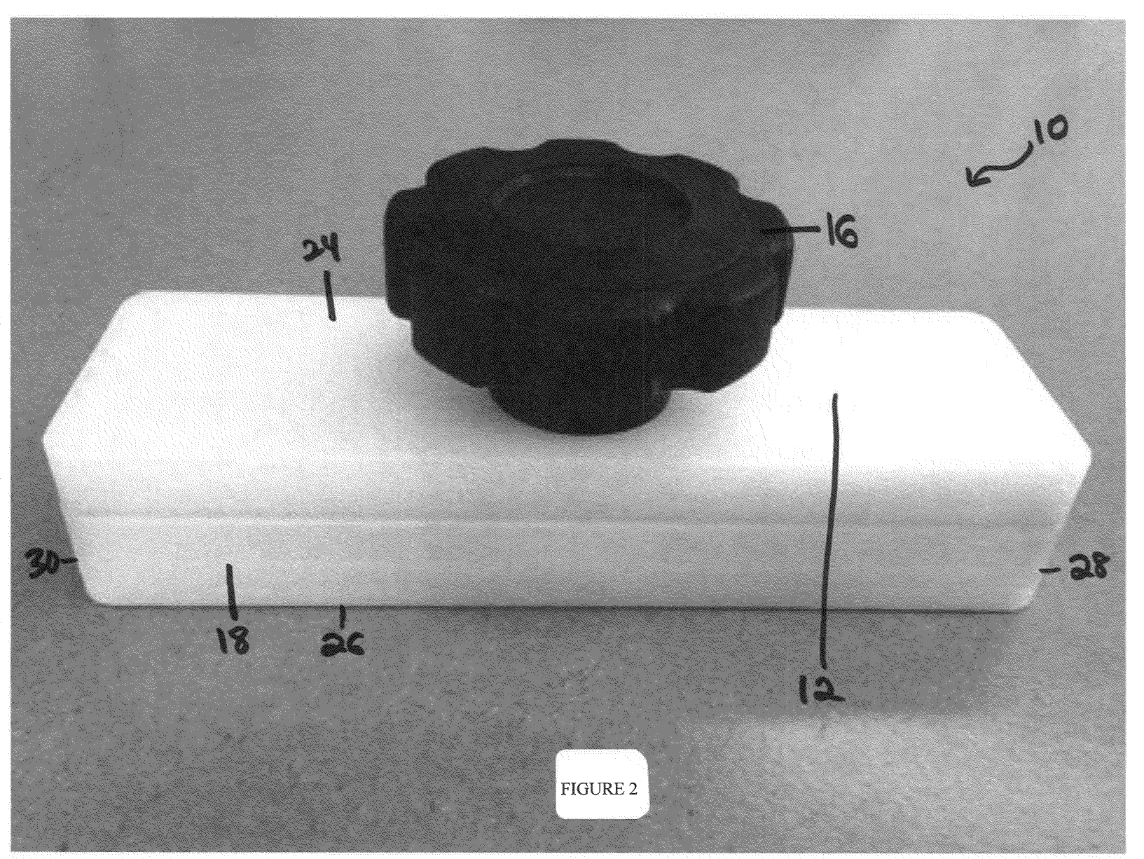

In the embodiments shown in FIGS. 1-4 and 13, the thickness of the slice of the food product is based on the distance of the cutting utensil 14 from the bottom surface 26 of the base unit 12. However, in alternate embodiments, one or more spacers can be used to increase the distance between the cutting utensil 14 and the bottom surface 26, thereby increasing the thickness of the slice of the food product. Spacers can be designed and assembled by those skilled in the art. In one embodiment, the spacer is the same length and width of the base unit 12, but has a different height depending on the desired thickness of the slice of the food product. Spacers can be of the same material, or a different material, as the base unit 12. In an embodiment, the spacer is affixed to the bottom surface 26 of the base unit 12. The spacer can be affixed to the base unit 12 by means of pins, screws, adhesive, fasteners, a snap-together assembly or other connections. In another embodiment, the spacer is affixed within the horizontal plane of disassembly location 22. For instance, the spacer may be affixed within the horizontal plane of disassembly location 22 such that the spacer lies directly adjacent to the cutting utensil 14. In these embodiments, the spacer can be attached by a number of means, such as screw(s) or a snap together assembly, wherein the spacer comprises male or female members for snapping together with the corresponding male or female members of the disassembly location 22.

The base unit may further comprise a handle 16. The handle 16 may be made from any material, including, but are not limited to, plastic, wood, metal, wire, or rubber. Referring to FIG. 1, the handle 16 can be a knob affixed to the top surface 24 of the base unit 12. The knob can have indentations for receiving one or more fingers, or be smooth with no indentations. In another embodiment, the handle 16 is “C”-shaped and attached to the top surface 24 of the base unit 12. In still another embodiment, as shown in FIGS. 3 and 4, the handle 16 is a stick or a rod affixed to the top surface 24 of the base unit 12. The handle 16 also may have an ergonomic design. Various embodiments providing an ergonomic design for the handle 16 will be known to those skilled in the art. In a further embodiment, the handle 16 can be effectively used by either a right-handed or left-handed user. In yet another embodiment, the handle 16 is adjustable in order to accommodate hands of different sizes. For example, the distance between the handle 16 and the base unit 12 can be adjusted to accommodate the user's grasp. In a further embodiment, the food product slicer 10 does not comprise a handle 16. In lieu of a handle 16, the base unit 12 itself may be manipulated in order to slice food products. In alternative embodiments, the handle 16 may also be affixed to the bottom surface 26, first end 28, second end 30, first side 20 or second side 18 of the base unit 12, or any combination thereof.

In one embodiment, the food product slicer 10 weighs more than about 10 lbs. In yet another embodiment, the food product slicer 10 weighs about 10 lbs., 9 lbs., 8 lbs., 7 lbs., 6 lbs., 5 lbs., 4 lbs., 3 lbs., 2 lbs., or 11b. In still another embodiment, the food product slicer 10 weighs about 3 lbs. to about 5 lbs.

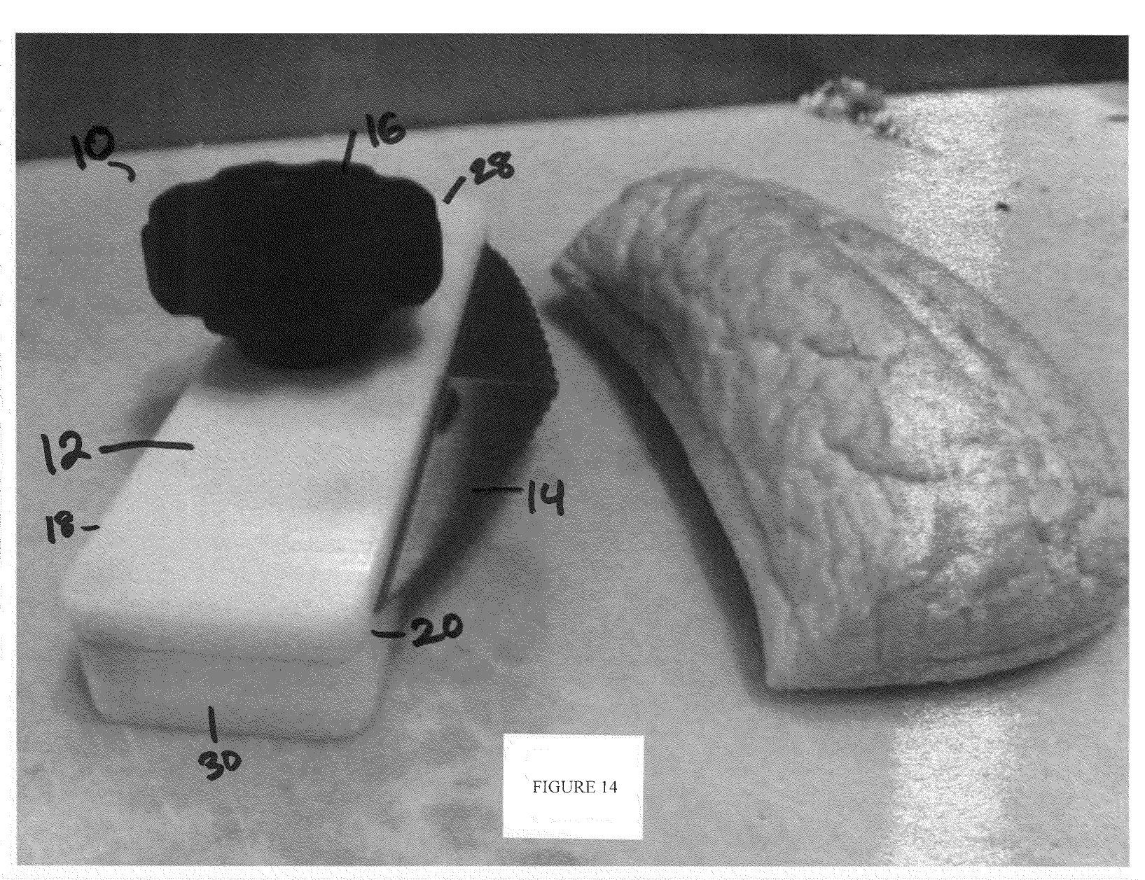

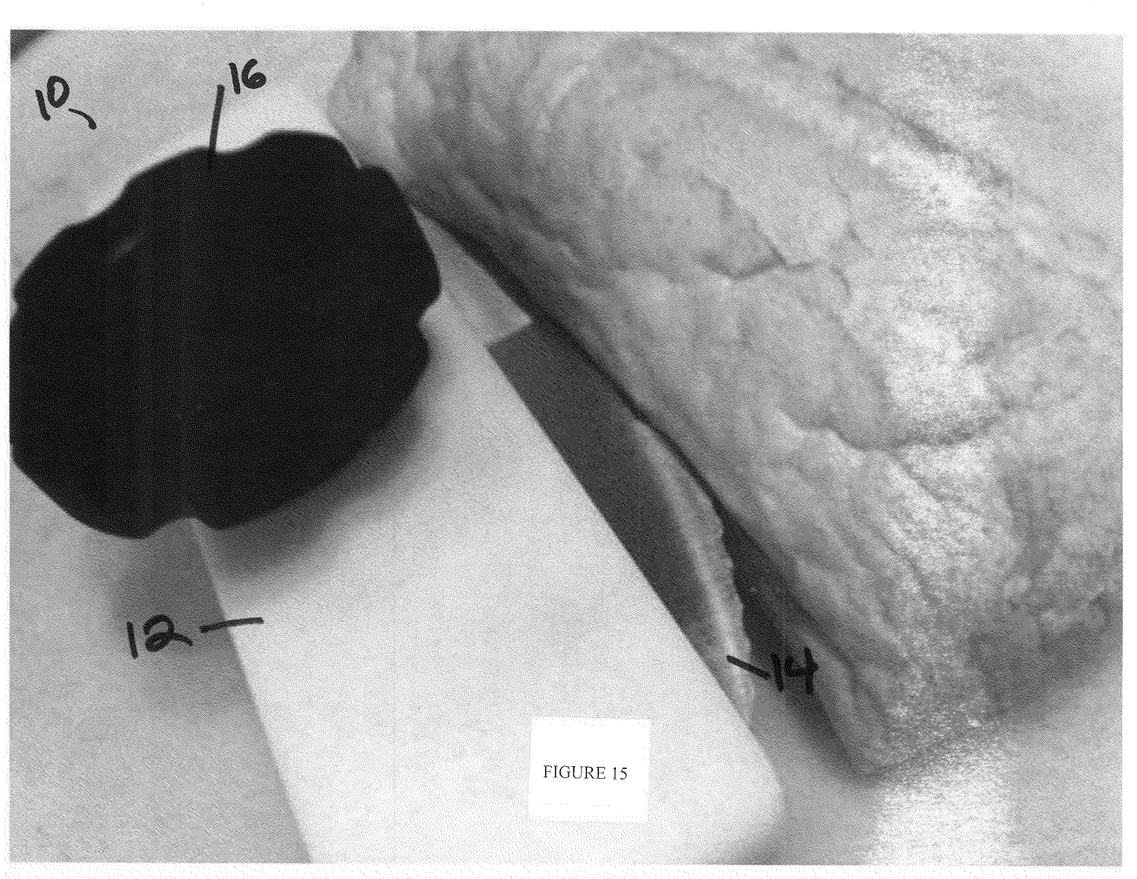

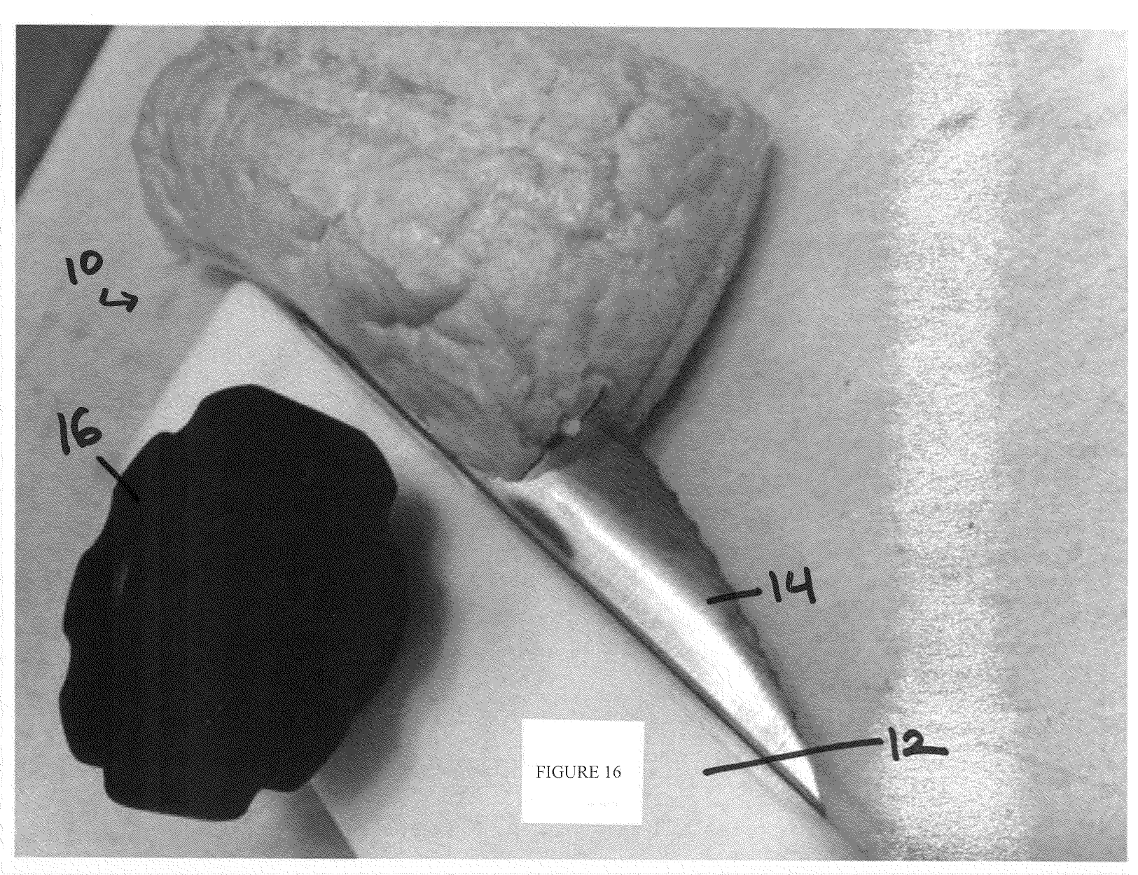

In operation, as shown in FIGS. 14-16, a food product such as bread, is abutted against a planar cutting surface. The cutting utensil 14 is secured to the first side 20 of the base unit 12 such that its cutting edge is parallel to the planar cutting surface. A user can employ the handle 16 to move the food product slicer 10 laterally in a horizontal direction in order to cut into the bread. FIG. 16 demonstrates that in one embodiment, the width of the cutting utensil 14 is less than the width of the bread, and accordingly, the bread is cut only partially along the length of one of its sides, and not completely into two separate pieces. The food product slicer 10 cuts the bread parallel to, and at a predetermined distance from, the planar cutting surface. Thus, the resulting slice is of a specific thickness based on the distance between the bottom surface 26 of the base unit 12 and the cutting utensil 14. As the food product slicer 10 is moved along the length of the bread, one side of the bread abuts the first side 20 of the base unit 12. Accordingly, in addition to the width of the cutting utensil 14, the first side 20 acts as a stopper and allows for control of the depth of the resulting cut. Allowing the user to control the depth of the cut provides for safe use of the food product slicer 10 by minimizing the risk to the user of cutting his or her hand on the cutting utensil 14. Because the cutting utensil 14 can be prevented from cutting all the way through the food product, the chance that the user's hand, which is grasping the food product, can be cut is diminished.

Those skilled in the art will appreciate that a variety of means exist for assembling the base unit 12, cutting utensil 14 and handle 16 of the present invention. For example, pins, screws, snaps, fasteners, or other connections may be used to assemble the elements of the food product slicer 10. In addition, the elements of the food product slicer 10 may be assembled by means of solder or welding. The food product slicer 10 may be fabricated or assembled as a single contiguous object, or may be assembled from clearly separate elements which cooperate to meet their required functions as disclosed herein.

The food product slicer 10 can cut a variety of food products, including, but not limited to, bread products such as loaves of bread, bagels, English muffins, or dinner rolls.

Those skilled in the art will also appreciate that the food product slicer 10 can slice a food product in a direction parallel or perpendicular to the planar cutting surface. In an embodiment, the food product slicer 10 can slice a food product at any angle relative to the planar cutting surface. For example, the food product slicer 10 can slice a food product at about a 15 degree, 30 degree, 45 degree, 60 degree or 75 degree angle.

While the present disclosure is capable of being embodied in various forms, for simplicity and illustrative purposes, the principles of the disclosure are described by referring to several embodiments thereof. It is understood, however, that the present disclosure is to be considered as an exemplification of the claimed subject matter, and is not intended to limit the appended claims to the specific embodiments illustrated. It will be apparent to one of ordinary skill in the art that the disclosure may be practiced without limitation to these specific details. In other instances, well-known methods and structures have not been described in detail so as not to unnecessarily obscure the disclosure.

Further, while the disclosure has been described in terms of several embodiments, it should be understood that there are many alterations, permutations, and equivalents that fall within the scope of this disclosure. It should also be noted that there are alternative ways of implementing both the process and apparatus of the present disclosure. It is therefore intended that the appended claim includes all such alterations, permutations, and equivalents as fall within the true spirit and scope of the present disclosure.

The use of the terms “a,” “an,” “the” and similar references in the context of this disclosure (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., such as, preferred, preferably) provided herein, is intended merely to further illustrate the content of the disclosure and does not pose a limitation on the scope of the claims. No language in the specification should be construed as indicating any non-claimed element as essential to the practice of the present disclosure.

The use of individual numerical values are stated as approximations as though the values were preceded by the word “about” or “approximately.” Similarly, the numerical values in the various ranges specified in this application, unless expressly indicated otherwise, are stated as approximations as though the minimum and maximum values within the stated ranges were both preceded by the word “about” or “approximately.” In this manner, variations above and below the stated ranges can be used to achieve substantially the same results as values within the ranges. As used herein, the terms “about” and “approximately” when referring to a numerical value shall have their plain and ordinary meanings to a person of ordinary skill in the art to which the disclosed subject matter is most closely related or the art relevant to the range or element at issue. The amount of broadening from the strict numerical boundary depends upon many factors. For example, some of the factors which may be considered include the criticality of the element and/or the effect a given amount of variation will have on the performance of the claimed subject matter, as well as other considerations known to those of skill in the art. As used herein, the use of differing amounts of significant digits for different numerical values is not meant to limit how the use of the words “about” or “approximately” will serve to broaden a particular numerical value or range. Thus, as a general matter, “about” or “approximately” broaden the numerical value. Also, the disclosure of ranges is intended as a continuous range including every value between the minimum and maximum values plus the broadening of the range afforded by the use of the term “about” or “approximately.” Thus, recitation of ranges of values herein are merely intended to serve as a shorthand method of referring individually to each separate value falling within the range, unless otherwise indicated herein, and each separate value is incorporated into the specification as if it were individually recited herein.

It is to be understood that any ranges, ratios and ranges of ratios that can be formed by, or derived from, any of the data disclosed herein represent further embodiments of the present disclosure and are included as part of the disclosure as though they were explicitly set forth. This includes ranges that can be formed that do or do not include a finite upper and/or lower boundary. Accordingly, a person of ordinary skill in the art most closely related to a particular range, ratio or range of ratios will appreciate that such values are unambiguously derivable from the data presented herein.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein.

Accordingly, this invention includes all modifications and equivalents of the subject matter recited in the claims appended hereto as permitted by applicable law. Moreover, any combination of the above described elements in all possible variations thereof is encompassed by the invention unless otherwise indicated herein or otherwise clearly contradicted by context.

I claim:

1. A food product slicer comprising:
a base unit having a first side, a second side, a top surface and a bottom surface;
a cutting utensil attached to the base unit at a predetermined distance from the bottom surface of the base unit, the cutting utensil having a cutting edge parallel to the bottom surface of the base unit; and
a handle attached to the base unit.

2. The food product slicer of claim 1, wherein the bottom surface of the base unit is generally planar for resting on a generally planar cutting surface.

3. The food product slicer of claim 2, wherein the bottom surface of the base unit further comprises a plurality of tabs for gliding across the generally planar cutting surface.

4. The food product slicer of claim 1, wherein the cutting utensil is attached to the first side of the base unit.

5. The food product slicer of claim 1, wherein the cutting utensil is replaceable.

6. The food product slicer of claim 1, wherein the base unit further comprises a disassembly location having a horizontal plane for separating the base unit along the horizontal plane and replacing the cutting utensil.

7. The food product slicer of claim 6, wherein the disassembly location further comprises a plurality of female and male members for snapping together the horizontal plane of the disassembly location.

8. The food product slicer of claim 4, wherein the cutting utensil further comprises a width measured from the cutting edge of the cutting utensil to the first side of the base unit, wherein the width of the cutting utensil is less than the width of a food product to be sliced.

9. The food product slicer of claim 1, further comprising a spacer for increasing the distance between the cutting utensil and the bottom surface of the base unit.

10. The food product slicer of claim 9, wherein the spacer includes male and female members for engaging the male and female members of the disassembly location.

11. The food product slicer of claim 1, wherein the cutting utensil is circular.

12. The food product slicer of claim 1, wherein the cutting edge is serrated or straight.

13. The food product slicer of claim 1, wherein the predetermined distance is about 0.5 inches to about 1 inch.

14. The food product slicer of claim 1, wherein the handle is attached to the top surface of the base unit.

15. The food product slicer of claim 1, wherein the handle is ergonomic.

16. A method for slicing a food product comprising the steps of:
a. placing a food product slicer on a generally planar support surface, the food product slicer comprising:
i. a base unit having a first side, a second side, a top surface and a bottom surface;
ii. a cutting utensil attached to the base unit at a predetermined distance from the bottom surface of the base unit, the cutting utensil having a cutting edge parallel to the bottom surface of the base unit; and
iii. a handle attached to the base unit;
b. placing the food product on the generally planar support surface adjacent to the cutting utensil;
c. moving the food product slicer across the generally planar support surface in a horizontal direction such that the cutting utensil cuts into the food product along a horizontal plane.

17. The method of claim 16, wherein the cutting utensil further comprises a width measured from the cutting edge of the cutting utensil to the first side of the base unit, wherein the width of the cutting utensil is less than the width of the food product.

18. The method of claim 16, wherein the cutting utensil is replaceable.

19. The method of claim 16, wherein the base unit further comprises a disassembly location having a horizontal plane for separating the base unit along the horizontal plane and replacing the cutting utensil.

20. The method of claim 16, wherein the cutting utensil is circular.
